(19) United States
(12) Patent Application Publication
(10) Pub. No.: US 2023/0032123 A1
(43) Pub. Date: Feb. 2, 2023

(54) FABRIC STRUCTURE

(71) Applicant: GEOX S.p.A., Montebelluna (IT)

(72) Inventors: Mario POLEGATO MORETTI, Crocetta Del Montello (IT); Marco BRUNO, Ivrea (IT); Christian MARCON, Povegliano, Frazione Camalo (IT); Livio POLONI, Caerano Di San Marco (IT)

(73) Assignee: GEOX S.p.A., Montebelluna (IT)

(21) Appl. No.: 17/789,810

(22) PCT Filed: Feb. 19, 2020
(86) PCT No.: PCT/EP2020/054313

§ 371 Date: Jun. 29, 2022

(51) Int. Cl. B32B 3/26; B32B 5/26; B32B 7/02

(52) U.S. Cl. CPC B32B 3/266; B32B 5/26; B32B 7/02; B32B 2262/0253; B32B 2262/103; B32B 2262/106; B32B 2307/302; B32B 2307/726; B32B 2437/00; B32B 2307/728; B32B 2307/73

(57) ABSTRACT

A fabric structure includes a first layer, which is breathable and adapted to be directed toward the body of the user, a second layer, which has preferential passages for sweat in the vapor phase leading outward from the first layer, a third layer, which is breathable and arranged opposite the first layer, the second layer being between the first layer and the third layer. The first layer includes fibers of heat-conducting material.

The present invention relates to a fabric structure.

Nowadays fabrics are known and widespread which are adapted to favor ventilation inside items of clothing, while at the same time favoring the removal of sweat in the vapor phase from the body of the user.

Such fabrics are particularly advantageous, especially in garments for use in hot weather or for sporting use.

In these circumstances, in fact, the body of the user requires a more effective removal of heat and of the sweat produced.

U.S. Pat. No. 5,746,013 by the company Faytex Corp., for example, contains the teachings for providing a fabric that comprises:
a knitted outer layer, of hydrophilic material,
a knitted inner layer, of hydrophobic material, which is arranged in contact with the body of the user and which is spaced apart from the outer layer,
a plurality of monofilament fibers of hydrophobic material, which extend between the outer and inner layers and which are interconnected with the layers, outer and inner, so as to space them apart and define an air chamber.

Such a fabric favors the removal of sweat in the liquid phase from the body of the user, but not the removal of sweat in the vapor phase.

EP 2007235 B1, by this same applicant, contains the teachings that represent an improvement over the fabric taught in U.S. Pat. No. 5,746,013.

In particular, EP 2007235 B1 contains the teachings for providing a fabric that comprises a layer, directed toward the body of the user, which is provided with preferential passages for removing sweat in the vapor phase by taking advantage of the phenomenon of convection: the “stack effect”.

This known art, although advantageous, also has aspects that can be improved: the preferential passages of the fabric are in fact constituted by the alternation of ridges, which are constituted by strips of fabric, in contact with the body of the user, and channels.

Locally, where the fabric is in contact with the body of the user, the convection mechanism is substantially nil.

This is due to the fact that convection is a phenomenon whereby heat and sweat in the vapor phase move, such motion being caused by a pressure gradient and characterized by circulation currents inside the fluid constituted by the air contained in the channels, which are obstructed, or even blocked, where the fabric adheres to the body of the user.

Furthermore, the fabric is constituted by yarns of polymeric material, mainly polyester, polypropylene and polyamide. These materials have a fairly low thermal conductivity, therefore they do not facilitate the dissipation of heat produced by the body of the user but, on the contrary, they contribute to its overheating, favoring and stoking a feeling of discomfort in the user.

The aim of the present invention is to provide a fabric structure that is capable of improving the known art in one or more of the above mentioned aspects.

Within this aim, an object of the invention is to provide a fabric structure that is capable of improve the dissipation of the heat produced by the body of the user.

Another object of the invention is to provide a fabric structure that is capable of favoring the removal of heat and sweat in the vapor phase by increasing the stack effect over conventional fabric structures.

A further object of the present invention is to overcome the drawbacks of the known art in an alternative manner to any existing solutions.

Another object of the invention is to provide a fabric structure that is highly reliable, easy to implement and of low cost.

This aim and these and other objects which will become better apparent hereinafter are achieved by a fabric structure comprising:
a first layer, which is breathable and adapted to be directed toward the body of the user,
a second layer, which has preferential passages for sweat in the vapor phase leading outward from said first layer,
a third layer, which is breathable and arranged opposite said first layer,

said second layer being comprised between said first layer and said third layer, said structure being characterized in that said first layer comprises fibers of heat-conducting material.

Further characteristics and advantages of the invention will become better apparent from the description of some preferred, but not exclusive, embodiments of the fabric structure according to the invention, which are illustrated for the purposes of non-limiting example in the accompanying drawings wherein:

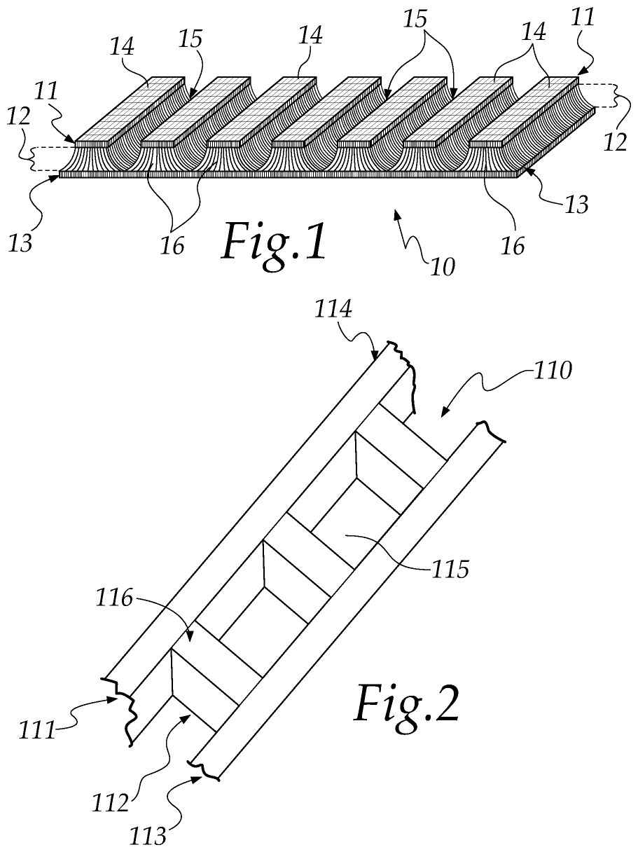

FIG. 1 shows a fabric structure according to the invention in a first embodiment;

FIG. 2 shows a fabric structure according to the invention in a second embodiment.

With reference to the figures, a fabric structure according to the invention is generally designated by the reference numeral 10.

The structure 10 comprises:
a first layer 11, which is breathable and adapted to be directed toward the body of the user,
a second layer 12, which has preferential passages for sweat in the vapor phase leading outward from the first layer 11,
a third layer 13, which is breathable and arranged opposite the first layer.

The third layer 13 is adapted to be directed toward the outside of the item of clothing to which the fabric structure 10 is applied.

The second layer 12 is comprised between the first layer 11 and the third layer 13.

One of the peculiarities of the invention consists in that the first layer 11 is constituted by a plurality of strips 14 of breathable and heat-conducting material.

The expression “heat-conducting material” means a material containing a plurality of heat-conducting fibers, which are characterized by a thermal conductivity higher than 0.06 W/m·K.

More preferably the thermal conductivity of the conducting fibers is higher than 0.08 W/m·K.

The strips of breathable and heat-conducting material 14 contain a percentage of conducting fibers that is conveniently higher than about 30%, more preferably higher than about 60%, and even more preferably higher than about 90%.

In a particularly advantageous embodiment such strips 14 are substantially constituted only by conducting fibers.

These strips 14 are characterized by a radiant flux value that conveniently is higher than 0.15 W/cm², more preferably higher than 0.17 W/cm², and even more preferably higher than 0.20 W/cm².

The radiant flux value is defined as a peak of the flow of heat transferred from a plate with a given surface and weight to a test piece which is at a lower temperature, determined an instant after the plate is placed in contact with the test piece.

This value is determined by testing five test pieces of fabric, square in shape and measuring 20 cm on a side, which are held for 24 hours under conditions of 20±2° C. and relative humidity of 65%±2%.

A measurement instrument is used which is known by the name of KES-F7 THERMO LABO II, or equivalent, waiting 15 minutes from switching on for all the parameters to reach normal levels.

The heating plate of the measurement instrument is switched on, setting the temperature to 35.0±0.1° C. The detector plate of the measurement instrument which, at thermal equilibrium, is at a temperature of 35.0±0.1° C., is arranged on the heating plate.

A container filled with water, which simulates the environmental conditions, is brought to the temperature of 20.0±0.1° C., and a test piece of fabric is positioned on it so that the face of the fabric that, in use, will be directed toward the body of a user, is directed upward.

The detector plate is placed rapidly on the test piece with a contact pressure of approximately 980 Pa and detection is simultaneously begun of the flow of heat transferred from the detector plate to the fabric, expressed in W/cm².

The average of the five experimental values obtained on the five test pieces is the radiant flux value.

An example of a material that is particularly suitable for the strips 14 is constituted by a material that comprises polyethylene fibers of the UHMW (ultra-high molecular weight) type, which is characterized by a thermal conductivity that exceeds about 0.1 W/m·K and is known by the commercial name of Tsunooga, from the company Toyobo Co., Ltd. in Osaka, Japan.

Another material that is particularly suitable for the strips 14 is constituted by a material that comprises polyethylene fibers of the UHMW type, known by the commercial name of Dyneema, from the company Royal DSM N.V. in Delft, the Netherlands.

Alternatively, fibers can be used which comprise heat-conducting materials such as for example copper, aluminum, graphene or the like.

The strips 14 can comprise fibers of non-heat-conducting material.

The expression “non-heat-conducting material” in the present description means a material with a thermal conductivity that is lower, at least by an order of magnitude, with respect to that of the heat-conducting material.

This non-conducting material is, for example, polyester and/or polyethylene and/or polyamide and/or the like.

Such materials have a thermal conductivity comprised between about 0.02 and about 0.04 W/m·K.

The composition of the strips 14 can be specified so as to obtain the best performance of the structure 10 in relation to the implementation costs.

The second layer 12 and the third layer 13, breathable, are constituted by fibers of a preferably synthetic material such as polyester and/or polyethylene and/or polyamide and/or the like.

The second layer 12 and the third layer 13 can comprise fibers of a conductive material in a variable percentage, for example, higher than about 30%, 60% or 90%.

Such second layer 12 and third layer 13 can be substantially constituted only by fibers of conductive material.

In particular, the second layer 12 defines preferential passages for the transit of sweat in the vapor phase leading outward from the first layer 11.

The term “preferential”, in the present description, means “tends to be preferred” by sweat which, in the vapor phase, when it encounters a material that has a zone with passages and a zone without, is attracted by the passages and tends to “prefer” them.

Sweat in the vapor phase prefers the zone that contains passages to the zone that does not.

Such preferential passages are constituted, in the embodiment shown in FIG. 1, by a series of channels 15, interleaved with a series of ridges 16.

In particular, one ridge 16 is placed between two consecutive channels 15.

These channels 15, when they are arranged predominantly vertically with respect to a configuration for use of the item of clothing, to which the fabric structure 10 is applied, favor the rise of sweat in the vapor phase from the bottom of the item of clothing upward.

The warm and humid air deriving from sweating tends, in fact, to expand naturally by virtue of its heat and to move upward from below by the stack effect.

It should be noted that some fibers of the second layer 12, because of the process of providing the fabric structure 10, can intersect with some fibers of the strips 14, without compromising their functionality.

At the ridges 16 the fabric structure 10, and in particular the first layer 11, is in contact with the body of the user and in such zones there is a considerable decrease in the stack effect, owing to the smaller space available for the warm humid air to expand compared to the space contained in the channels 15.

At the ridges 16 the first layer 11, heat-conducting, subtracts heat from the body of the user, transferring it to the second layer 12.

In this manner the temperature of the body decreases, preventing it from overheating and limiting sweating, with a consequent improvement in the comfort perceived by the user.

In its passage through the second layer 12 this heat, subtracted by the first layer 11 from the body of the user, heats the warm humid air contained within the channels 15, favoring its rise upward, and therefore acting as promoter of the stack effect.

If the second layer 12 and/or the third layer 13 comprise, advantageously, fibers of conductive material, the latter facilitate the passage of the heat to outside the structure 10 and therefore far from the body of the user.

The conduction of heat occurs substantially instantaneously, and continuously promotes the mechanism of convection.

The convection, in turn, by virtue of the air circulation currents, cools the second layer 12.

Lowering the temperature of the second layer 12, and as a consequence of the first layer 11, promotes the flow of heat direct from the body of the user toward the first layer 11.

The combined action, owing to the phenomenon of conduction and to the phenomenon of convection, by delaying and limiting sweating, enable an improvement of the comfort perceived by the user.

The width of the strips 14 of fabric is comprised between about 2 mm and about 6 mm.

The thickness of the ridges 16 of the second layer 12 is comprised between about 1.5 and about 4 mm.

The average width of the channels 15, between two successive ridges 16, is between about 1.5 and about 8 mm.

The fibers that make up the second layer 12 are interwoven with the fibers that make up the first layer 11 and the third layer 13.

The term “interwoven” in the present description means that the fibers of the second layer 12 crisscross and/or intersect and/or interweave with the fibers of the first layer 11 and the third layer 13, while remaining separate from them, in order to fix the second layer 12 to the other two layers 11 and 13.

The yarn count of the heat-conducting material used for the first layer 11 is preferably 200 denier.

The yarn count of the non-heat-conducting material used for the first layer 11 is preferably 75 denier.

The yarn count used for the second layer 12 is preferably 30 denier.

The yarn count used for the third layer 13 is preferably 75 denier.

FIG. 2 shows a fabric structure 110 according to the invention in a second embodiment.

In this embodiment the first layer 111 of the structure 110 has a substantially continuous surface 114 for contact with the body of the user.

In this embodiment, a plurality of ridges 116 is interleaved with a plurality of ducts 115 in the second layer 112.

In particular, a ridge 116 is placed between two successive ducts 115.

This embodiment is advantageous, with respect to the previous one, because it makes it possible to increase the surface used to subtract heat from the body of the user.

Preferably the fabric structure 10, 110 is made of three-dimensional fabric i.e. a single fabric in which the constituent fibers are arranged in a mutually perpendicular planar relationship. From the point of view of the process of manufacture, in a weaving of the 3D type, the sets of X and Y fibers are braided with the rows and columns of the axial Z fibers.

“Sets of X and Y fibers” means respectively the horizontal and vertical weft sets. “Z fibers” means the multilayer warp set.

It is also possible to obtain three-dimensional fabrics with weaving processes of the 2D type. The three-dimensional fabric can also be obtained by knitting on flat or circular knitting machines.

Advantageously the first layer 11, 111, is hydrophobic.

Advantageously the second layer 12, 112, is hydrophobic.

Advantageously the third layer 13, 113, is hydrophilic.

The hydrophobic first layer 11, 111 pushes the liquid sweat toward the hydrophilic third layer 13, 113, in this manner favoring the removal from the body of the user.

In practice the fabric structure 10, 110 permits the evacuation of heat by taking advantage both of the principle of thermal conduction and of the principle of convection, i.e. the stack effect.

In practice it has been found that the invention fully achieves the intended aim and objects by providing a fabric structure that improves the dissipation of the heat produced by the body of the user, with respect to conventional fabric structures, and favors the removal of heat and sweat in the vapor phase by increasing the stack effect over conventional fabric structures.

The invention thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102018000010418 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. fabric structure comprising:
a first layer, which is breathable and adapted to be directed toward the body of the user;
a second layer, which has preferential passages for sweat in the vapor phase leading outward from said first layer; and
a third layer, which is breathable and arranged opposite said first layer,
wherein said second layer is comprised between said first layer and said third layer, and
wherein said first layer comprises fibers of heat-conducting material.

2. The structure according to claim 1,
wherein said second layer and said third layer comprise a percentage of fibers of heat-conducting material greater than 30%, more preferably greater than 60%, even more preferably greater than 90%.

3. The structure according to claim 1, wherein said first layer is substantially constituted only by fibers of heat-conducting material and in that said heat-conducting material is UHMW polyethylene and/or copper and/or aluminum and/or graphene and/or the like.

4. The structure according to claim 1, wherein at least one among said first layer, said second layer and said third layer comprises fibers of nonconducting material which are constituted by polyester and/or polyethylene and/or polyamide and/or the like.

5. The structure according to claim 1, wherein said fibers of conducting material are characterized by a heat conductivity greater than 0.06 W/m·K, more preferably greater than 0.08 W/m·K.

6. The structure according to claim 1, wherein said preferential passages are constituted by a plurality of channels and/or ducts, which are interleaved by a plurality of ridges.

7. The structure according to claim 1, wherein said first layer is constituted by a plurality of strips with a width comprised between approximately 2 mm and approximately 6 mm.

8. The structure according to claim 1, wherein said first layer has a substantially continuous surface that contacts the body of the user.

9. The structure according to claim 1, wherein said ridges have a thickness comprised between approximately 1.5 mm and approximately 4 mm.

10. The structure according to claim 1, wherein said channels and/or said ducts have an average width, between two successive ridges, comprised between approximately 1.5 mm and approximately 8 mm.

11. The structure according to claim 1, wherein said first layer has a yarn count of said heat-conducting material preferably of 200 denier and has a yarn count of said non-conducting material preferably of 75 denier.

12. The structure according to claim 1, wherein said second layer has a yarn count preferably of 30 denier.

13. The structure according to claim 1, wherein said third layer has a yarn count preferably of 75 denier.

14. The structure according to claim 1, wherein said first layer is hydrophobic and/or aid second layer is hydrophobic.

15. The structure according to claim 1, wherein said third layer is hydrophilic.
